(19) United States
(12) Patent Application Publication
(10) Pub. No.: US 2024/0390713 A1
(43) Pub. Date: Nov. 28, 2024

(54) SYSTEM, VEHICLE PARKING ENVIRONMENT AND METHOD FOR EXTINGUISHING A FIRE IN AN ELECTRIC VEHICLE

(71) Applicant: SP/F 28. JUNI 2000, Faroe Islands (DK)

(72) Inventor: Tummas Justinussen, Faroe Islands (DK)

(73) Assignee: SP/F 28. JUNI 2000, Faroe Islands (DK)

(21) Appl. No.: 18/696,623

(22) PCT Filed: Oct. 11, 2022
(86) PCT No.: PCT/IB2022/059731

§ 371 Date: Mar. 28, 2024

(30) Foreign Application Priority Data
Oct. 11, 2021 (EP) 21201842.8

(51) Int. Cl. A62C 3/10; A62C 31/22; A62C 99/00

(52) U.S. Cl. CPC A62C 3/10; A62C 31/22; A62C 99/0009

(57) ABSTRACT

The invention relates to a method, a system, a vehicle parking environment, and method for extinguishing a fire in an electric vehicle, where the system comprises a storage medium, such as a tank, containing a fire extinguishing medium, and a cooling system for cooling the fire extinguishing medium to a sub-zero temperature, and a delivery system for delivering the fire extinguishing medium from the storage medium to the inside of a vehicle.

### TECHNICAL FIELD

The present invention relates to a system, a vehicle parking environment, and a method for extinguishing a fire in a vehicle, with special focus on an electrical vehicle.

### BACKGROUND OF THE INVENTION

During recent years, the number of electric vehicles (EV's) has increased significantly e.g. due to the environmental impact of the electric cars on the environment, compared to fuel consuming cars.

Lithium-ion batteries, such as the ones used in EV's or electronic devices, may catch fire or overheat if they have manufacturing errors, have been damaged, or the controlling and/or monitoring of the battery is not functioning correctly.

EV batteries run at high voltage, typically between 400 v and 800 v, where 800 v will probably become the norm in the future.

An EV battery catching fire, due to the above-defined issues, or any other causes, looks like a spontaneous combustion, e.g. like in fuel consumption vehicles, however, the internal burning process within the battery is called a “thermal runaway” and is different from a normal burning process.

Unlike a fire in a fuel consuming vehicle where just one single reaction occurs, a fire in an EV battery comprises multiple steps. Essentially, an uncontrolled, cascading loop of violent chemical reactions releases a tremendous amount of energy and heat, and as the individual battery cells warm up, energy and heat drives through the rest of the battery in a kind of domino effect.

What makes this worse is the fact that as the thermal runaway accelerates, the burning battery's stored energy essentially creates its own fuel (oxides). It's a chemical fire which doesn't necessarily need oxygen, hereby making it far harder to extinguish than a petrol fire. With the oxides present in the battery cells, temperatures from approx. 180° C. causes oxygen to be released in the battery, which reacts with cell components, in particular the electrolyte, which again leads to an exothermic reaction that cannot be stopped, during which the battery burns.

The fires emit combustible and harmful gases such as hydrogen fluoride, and thanks to its internal thermal runaway the fire will not burn out.

A burning battery or an overheated battery in a parking environment, such as ferries, parking garages, underground parking, parking lots, tunnels etc. which might catch fire, provides a severe risk of human injury, and especially if the parking environment is a ferry, it provides a risk of the entire ship catching fire and thus resulting in a disaster.

Prior art systems propose internal sprinkler systems within the vehicle, or batteries which are arranged in an insulated container within the vehicle, however, the process of installing an individual sprinkler system inside a vehicle is costly and almost impossible as the available room in a vehicle for such a system is very limited, and further, such systems deliver a very limited amount of fire extinguishing material. Further, as described above, as the burning batteries create their own oxygen, the burning process continues for a long time, whereby an insulated container eventually would be melted or damaged. The fire would spread to the rest of the vehicle and eventually to the surroundings of the vehicle.

It is an object of the present invention to provide a system, a vehicle parking environment, and a method for extinguishing a fire in an electric vehicle in which the above-defined drawbacks are avoided.

In particular, it is an object of the invention to provide a system which can be arranged outside a burning vehicle, which is able to provide a large amount of fire extinguishing material to a burning or over-heated EV battery and/or burning vehicle in a safe, easy and automated manner.

It is a second object of the invention to provide a parking environment, in which a number of vehicles are parked, where a burning vehicle battery or an overheated battery may be extinguished and/or cooled down, such that the vehicle no longer poses a risk, or the vehicle can be removed from the parking area without causing further damage to the surroundings.

It is a third object of the invention to provide a method for extinguishing and/or cooling down a battery in an EV, where a cooling medium is injected into the vehicle, and a burning vehicle battery or an overheated battery may be extinguished and/or cooled down, such that the vehicle no longer poses a risk or the vehicle can be removed from the parking area without causing further damage to the surroundings.

The above object and advantages, together with numerous other objects and advantages, which will be evident from the description of the present invention, are according to a first aspect of the present invention obtained by:
A fire extinguishing system for extinguishing a fire in a vehicle, such as an electric car, the system comprising:
a storage medium, such as a tank, being external to the vehicle, and containing a fire extinguishing medium,
a cooling system for cooling the fire extinguishing medium to a subzero temperature, and a delivery system for delivering the fire extinguishing medium from the storage medium to the inside of the vehicle,
the delivery system comprising an injection system having mechanically operated and combined piercing and injection means, for piercing and injecting the fire extinguishing medium into the car.

The fire extinguishing system is preferably arranged proximate locations having a number of parked vehicles, such as ferries, parking garages, underground parking, parking lots, tunnels etc.

The fire extinguishing system comprises a storage medium which contains the fire extinguishing medium which is to be injected into the vehicle.

The fire extinguishing medium is cold, such as having a temperature below 0 degrees Celsius, and the storage medium is preferably insulated and comprises internal means for circulating the fire extinguishing medium within the storage medium.

The storage medium may comprise internal circulation means, such as a circulation pump, for circulating the cold fire extinguishing medium within the storage medium in order to ensure a uniform cold temperature.

The storage medium and the cooling system are arranged such that the fire extinguishing medium can be circulated between the storage medium and the cooling system for cooling the fire extinguishing medium to a predefined cold temperature. The fire extinguishing system preferably comprises a circulation pump for circulating the fire extinguishing medium between the storage medium and a heat exchanger of the cooling system, such as an evaporator.

The fire extinguishing system further comprises a delivery system for delivering the fire extinguishing medium from the storage medium and into the vehicle.

The delivery system comprises combined piercing and injection means which, via a piping and/or hose system, is connected to the storage medium whereby the fire extinguishing medium can by delivered from the storage medium and into the vehicle. The piping system is preferably an insulated piping system for carrying the fire extinguishing medium, and the hose system may be arranged as a flexible hose, similar to a firefighting hose.

The combined piercing and injection means is preferably arranged as a longitudinal arm, arranged above a parked vehicle, such as arranged on a ceiling of a parking environment e.g, a parking area on a ship. One end of the longitudinal arm being pivotally connected above the vehicle, and the other end of the arm comprising a piercing and injection element, such as pointy element arranged as a piercing nozzle, or drilling unit, harpooning unit i.e., a pointy end with an opening therethrough for delivering the fire extinguishing medium. The arm may be hollow such that the medium may be delivered through the arm but may also be arranged with an external positioned hose connected to the combined piercing and injection element.

In order for the storage medium to deliver the stored fire extinguishing medium into e.g., a burning EV, the storage medium preferably comprises a pump which may be integrated with the storage medium. In another embodiment, an external pump may be connected to the storage medium for pumping out the fire extinguishing medium.

According to a further embodiment of the first aspect of the invention, the combined piercing and injection means, being arranged as a mechanically moving element, moveable between two positions, a first stored position in which the piercing and injection means are disengaged from the vehicle, and a second deployed position, where the piercing and injection means have pierced the vehicle, such that the fire extinguishing medium may be delivered into the vehicle through the combined piercing and injection means.

The combined piercing and injection means, which may be arranged as an arm, is arranged to be moveable between a first stored position in which the piercing and injection means are disengaged from the vehicle, and a second deployed position, where the piercing and injection means have pierced the vehicle. The injection and piercing means may comprise releasing means, such as spring actuated releasing means, which ejects/releases the piercing and injection means 52 from the first position into the second position, with a force suitable for penetrating the roof of the vehicle. The releasing means may be arranged as mechanical, pneumatic or hydraulic means, suitable for rapidly ejecting the piercing and injection means from the first position. The piercing and injection means thus functions as a hammer with a sharp piercing nozzle, a drilling unit or harpooning system at the end which penetrates the vehicle.

The piercing and injection means are brought into the second position by a force and speed suitable for penetrating the roof of the vehicle.

After the vehicle has been pierced, the fire extinguishing medium can be delivered into the car. By such arrangement it is possible to arrange the fire extinguishing system into existing parking environments, such as a ferry or parking cellar etc. without the fire extinguishing system being any obstruction to the parked cars.

The combined piercing and injection means may be arranged in connection with a robot or jib arm having the combined piercing and injection means arranged at an end thereof.

According to a further embodiment of the first aspect of the invention, the delivery system comprising a guide system, such as a number of steel rails, onto which the combined piercing and injection means are moveable connected, such that the combined piercing and injection means are displaceable in a longitudinal direction of the guide system.

The fire extinguishing further system comprises a guide system, such as a number of steel rails arranged above the cars, such as arranged in connection with a ceiling, or suspended below the ceiling.

The guide system provides a support for the piercing and injection means, which may be moveable arranged onto the guide system. A number conveying means, such as rollers, may be connected between the guide system and the piercing and injection means such that the piercing and injection means being displaceable in a longitudinal direction of the guide system, such as the longitudinal direction of the steel rails.

It is hereby possible to position the piercing and injection means correctly above a parked vehicle before the piercing and injection means is being brought into the second position for injection of the fire extinguishing medium into the vehicle.

According to a further embodiment of the first aspect of the invention, the delivery system comprising support means, supporting the combined piercing and injection means, the support means comprising a release mechanism, for releasing said combined piercing and injection means from said first position into said second position.

The delivery system comprises supporting means, such as steel supporting arms, suspending the combined piercing and injection means from the guide system. Hereby, in connection with a single row of steel rails, the supporting means support a number of combined piercing and injection means on each side of the guide system. As an example, one combined piercing and injection means may be arranged on each side of the guide system. Alternatively, two or more combined piercing and injection means may be arranged on each side of the guide means.

The releasing means of the piercing and injection means may comprise individually operated releasing means, such as magnetic valves at the point where the piercing and injection means are fixed to the support means, such that when a number of piercing and injection means are used in a fire extinguishing system, each piercing and injection element can be operated remotely and independently.

Alternatively, the delivery system may be arranged with a solution having just one combined piercing and injection means. In this alternative, the combined piercing and injection means are arranged displaceable on the supporting means, in a lateral direction in relation to the guide system.

According to a further embodiment of the first aspect of the invention, the fire extinguishing medium being a brine.

The fire extinguishing medium is preferable a brine, which is a high concentration of salt (typically sodium chloride) in a liquid such as water. Brine may be a salt solution ranging from 3.5% up to approximate 26% which will typically be a completely saturated solution. Brine is typically used in the cooking industry, where brine is used to preserve or season the foods.

Brine is also used as a secondary fluid in large refrigeration systems for the transport of thermal energy and may also be used for de-icing, e.g., the de-icing of roads.

An advantage of using brine as a fire extinguishing medium, is that the medium is capable of carrying a very large amount of cooling energy into the interior of the vehicle, and therefore into contact with the burning or overheated EV battery. E.g., when brine is applied at a 23.3% concentration (76.7% water), it will freeze (without any additional dilution) at approx. −21 degrees Celsius. Arranging the brine with a higher salt concentration lowers the freezing temperature to as low as approximate-50 degrees Celsius.

According to a further embodiment of the first aspect of the invention, the fire extinguishing medium comprising an antifreeze liquid coolant.

In order to increase the maximum lower temperature of the fire extinguishing medium, it may comprise anti-freeze agents, such as ethylene or propylene glycerol. Using such agents may lower the freezing temperature of the brine, even below-50 degrees Celsius.

According to a further embodiment of the first aspect of the invention, the fire extinguishing medium having a temperature of below 0 degrees Celsius, preferably a temperature below −20 degrees, such as between −20 and −50 degrees, most preferred between −20 and −30 degrees.

In the most preferred embodiment, the fire extinguishing medium, such as a brine, has a temperature of between −20 and −30 degrees. Arranging the medium with such temperature, provides the most optimal cooling temperature, compared to the energy used for the cooling system to cool down the medium. Depending on the size of the burning and/or overheated battery, a temperature of between −20 and −30 is sufficient to extinguish/cool down a standard-sized EV battery.

If the fire extinguishing system is to be used for larger EV vehicles, such as EV trucks or busses having larger sized batteries, a lower temperature of the medium may be needed.

According to a further embodiment of the first aspect of the invention, the viscosity of the fire extinguishing medium is increased compared to the viscosity of water at 0 degrees Celsius.

When pumping the fire extinguishing medium into a vehicle, the increased viscosity minimizes the flowing out of the fire extinguishing medium through small openings of the car/decreases the rate of flowing out. Hereby, the fire extinguishing medium is concealed within the vehicle for a longer period of time.

According to a further embodiment of the first aspect of the invention, the brine has a concentration of above 20%.

Arranging the brine with a concentration of 20% (80% water) provides the possibility, without the use of additives, such as anti-freeze agents, to cool the brine to a temperature of below −20 degrees Celsius.

The cooling system provides the possibility of continuously circulating the fire extinguishing system between the storage medium, such as a tank, and a heat exchanger, such as an evaporator in the cooling system. The system may comprise a control system having sensors, such as temperature sensors for continuously monitoring the temperature of the fire extinguishing medium, such that the medium always has a desired temperature.

According to an embodiment of the first aspect of the invention, the cooling system is arranged for circulating the fire extinguishing medium, the storage medium and the cooling system being arranged modularly, such that the storage medium can be disconnected from the cooling system.

The fire extinguishing system is preferably arranged as a modular system, such that the storage medium may be disconnected and transported to another location of need, for extinguishing a fire in a remotely located EV. The fire extinguishing system may therefore be arranged with a conduit system between the storage medium and the cooling system, where the conduit system comprises a releasable coupling system for disconnecting the storage medium from the cooling system. Preferably, the conduit system comprises a bypass for continuously circulating the fire extinguishing medium through the heat exchanger.

Hereby, the storage medium can easily be disconnected from the cooling system and transported, e.g., on a truck, to a remote location. Further, the storage medium and the conduit system is preferably heat insulated such that the temperature of the fire extinguishing medium is best preserved.

In this embodiment, the piercing and injection means may preferably be arranged in a robot or jib arm in connection with the truck. Hereby the system functions as a mobile system.

The fire extinguishing system may be arranged in relation to a parking environment such as a ferry, parking garages, underground parking, parking lots, tunnels etc. where these environments may have a relatively large parking area comprising a large number of parked vehicles.

In such situations, it is necessary for the fire extinguishing system to be able to cover the entire area and thereby being able to extinguish a fire in a most remotely located vehicle. In relation to ferries, underground parking facilities, and multilevel parking garages, it as desirable for the fire extinguishing system to cover all levels.

Therefore, it is preferred that the fire extinguishing system comprises a delivery system having a first part which is stationarily arranged in relation to the storage medium and the cooling system. The stationary first part preferably comprises a number of insulated pipes/conduits fixedly installed in the environment, such as a ferry, garage etc. The first stationary part may be a grid of pipes which extends from the storage medium over a main part of the parking area, and if the parking area covers multiple levels, the grid preferably extends over the individual levels.

The fire extinguishing system further comprises a second flexible part, arranged non-stationarily in relation to the storage medium and the cooling system, and arranged for delivering the fire extinguishing medium from the storage medium via the combined piercing and injection means, and into the vehicle for extinguishing/cooling down the EV battery. The second flexible part is preferable arranged as a hose, which is typically a firefighting hose, and coupled to the stationary part, via a valve, such as a hose valve, in a disconnectable manner.

The stationary first part preferable comprises several of such valves, located along the insulated pipes/conduits or over the grid, at specific locations. Hereby, when a fire or an overheated battery in a vehicle is detected, the second flexible part is coupled to the nearest valve, such that the second flexible part may reach the vehicle, e.g., down through a row of parked cars, for pumping in the fire extinguishing medium.

Alternatively, the second flexible part may be coupled directly to the storage medium for delivering the fire extinguishing medium without using the first stationary part. It is hereby achieved that the system can deliver fire extinguishing medium outside the area of the first stationary part. This embodiment is particularly useful in the situation as described earlier, where the storage medium is disconnected from the cooling system and transported elsewhere e.g., on a truck, for use at a remote location.

According to a further embodiment of the first aspect of the invention, the storage medium, having a storing capacity being substantially equal to, or higher than a predetermined volume corresponding to an estimated internal volume of the vehicle.

The aim of the fire extinguishing system is to extinguish or prevent fires in specific vehicle sizes. An object is to inject fire extinguishing material primarily into passenger vehicles such as cars, where the internal volume of such cars does not vary a great deal compared to e.g. the internal volume of a bus. A typical volume of a family car of course varies, dependent on the model, but is typically approx. 3-5 m³.

Therefore, when installing the system, it is known what type of vehicles are the target of the fire extinguishing system, and the volume of the storage medium is therefore preferably within 3-5 m³, and preferably above such that the system can continue pumping fire extinguishing medium into the vehicle, after the vehicle has been substantially filled.

In a further embodiment, the storage medium may comprise an adjustable interior volume, such that the amount of fire extinguishing material within the storage medium can be regulated according to need. For that purpose, the storage medium comprises an interior wall element which may be displaced within the storage medium, hereby decreasing, or increasing the interior volume, in which the fire extinguishing medium is stored.

According to a further embodiment of the first aspect of the invention, the system comprises a salt concentration regulating mechanism.

The system preferably comprises a salt regulating mechanism, such as a salt regulating mechanism arranged in connection with the cooling system. The system may comprise sensors for detecting the salt concentration of the fire extinguishing medium, and if the salt concentration falls outside a certain predefined range, such as a minimal lower value, the salt regulating mechanism adds an amount of salt, such that the concentration falls within the predefined range.

If the temperature of the fire extinguishing medium is to be lowered compared to a present situation, the salt concentration may not be high enough, whereby there is a risk that the fire extinguishing medium freezes. To prevent the temperature of the fire extinguishing medium falling below a specific freezing point when a lower temperature is needed, the salt concentration regulation mechanism adds salt to the fire extinguishing medium and hereby increasing the concentration.

According to a second aspect of the present invention, the above objects and advantages are obtained by:
A vehicle parking environment comprising a vehicle parking area and a fire extinguishing system according to the invention.

By arranging a vehicle parking environment with the above-defined system, it is possible to arrange a parking environment, in which a number of vehicles are parked, where a burning vehicle/battery or an overheated battery, safely, fast and easily can be extinguished and/or cooled down, such that the vehicle no longer poses a risk or the vehicle can be removed from the parking area without causing further damage to the surroundings.

It is preferred that the storage medium and the cooling system is located outside the parking area. In the event of a spreading fire, the storage medium and cooling system is not directly compromised and may therefore still operate. In such an event, the stationary first part of the delivery system, which preferably comprises a number of installed and insulated pipes, may get damaged because of the fire, and may no longer be functional. In order for the fire extinguishing system to still be able to work, the storage medium is provided with means, such as e.g. a hose valve, for connecting the flexible second part of the fire extinguishing system directly to the storage medium.

According to a third aspect of the present invention, the above objects and advantages are obtained by:
A method for extinguishing a fire in a vehicle, such as an EV, the method comprising the following steps:
   providing a fire extinguishing system according to the invention,
   providing an opening into the vehicle, by the combined piercing and injection means, injecting a fire extinguishing medium through the opening and into the vehicle via said combined piercing and injection means (52), and
   optionally continuing injecting the fire extinguishing medium until the vehicle is between half and substantially completely filled with the fire extinguishing medium, and
   optionally continuing injecting the fire extinguishing medium after the vehicle is substantially filled with the fire extinguishing medium.

With the above-defined method, there is provided a method for extinguishing and/or cooling down a battery in an EV, where a cooling medium is injected into the vehicle, and a burning car battery or an overheated battery can be extinguished and/or cooled down in an safe, easy and fast manner, such that the car no longer poses a risk or the vehicle can be removed from the parking area without causing further damage to the surroundings.

According to a further step of the third aspect of the invention, the step of providing an opening into the vehicle by the combined piercing and injection means, comprises an operation of the combined piercing and injection means from a first stored position, in which the piercing and injection means are disengaged from the vehicle, and into a second deployed position, where the piercing and injection means have pierced the vehicle such that the fire extinguishing medium can be delivered into the vehicle through the combined piercing and injection means.

Upon detection of a burning vehicle or an overheated battery, either visually by any personal or automatically by a sensor system, such as a smoke or heat sensor, the fire extinguishing system may automatically deploy the combined piercing and injection means from the first position and into the second position.

According to a further step of the third aspect of the invention, wherein preceding the step of providing an opening into the vehicle, the method comprises a positioning step, where the combined piercing and injection means are moved on a guide system, such that the combined piercing and injection means are maneuvered into a correct position above the vehicle before the combined piercing and injection means are released from the first position into the second position.

Before the combined piercing and injection means are positioned into the second position, the delivery system which comprises the guide system are maneuvered into a correct position above the vehicle. Vehicles may be parked differently, i.e., not in a specific position, and the delivery system hereby provides the possibility of adjusting the position of the piercing and injection means into a correct position in relation to the vehicle.

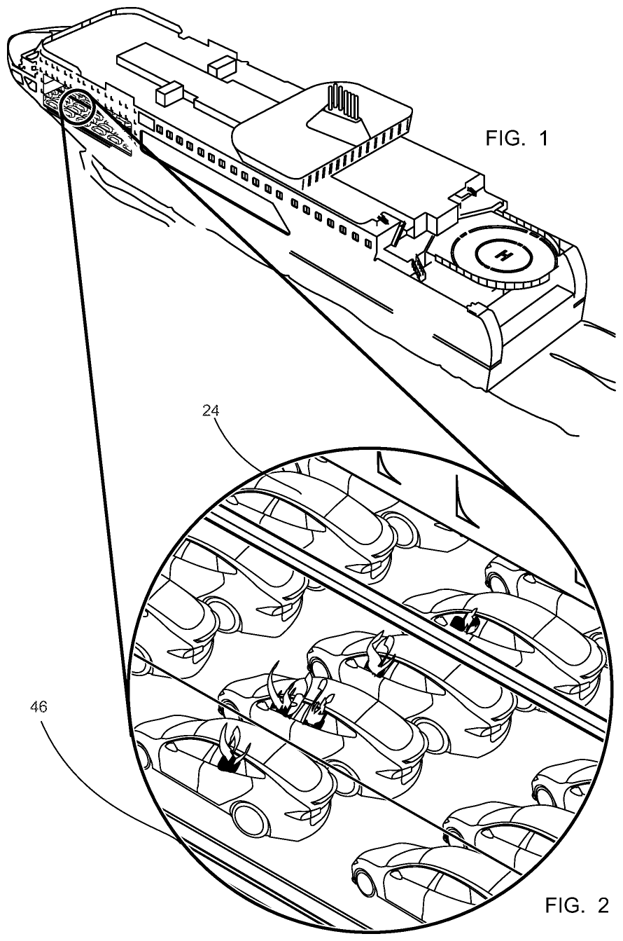

FIG. 1 shows a perspective view of a ship having a parking area with a burning car.

FIG. 2 shows a view of a cross-section through the ship in FIG. 1.

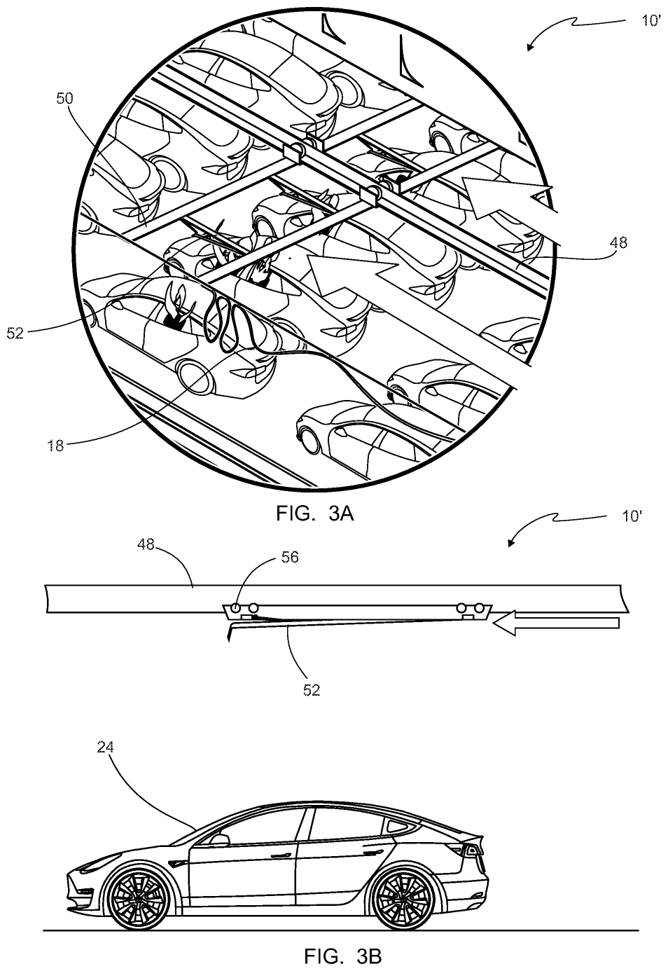

FIG. 3A shows a perspective view of a delivery system.

FIG. 3B shows a side view of a delivery system.

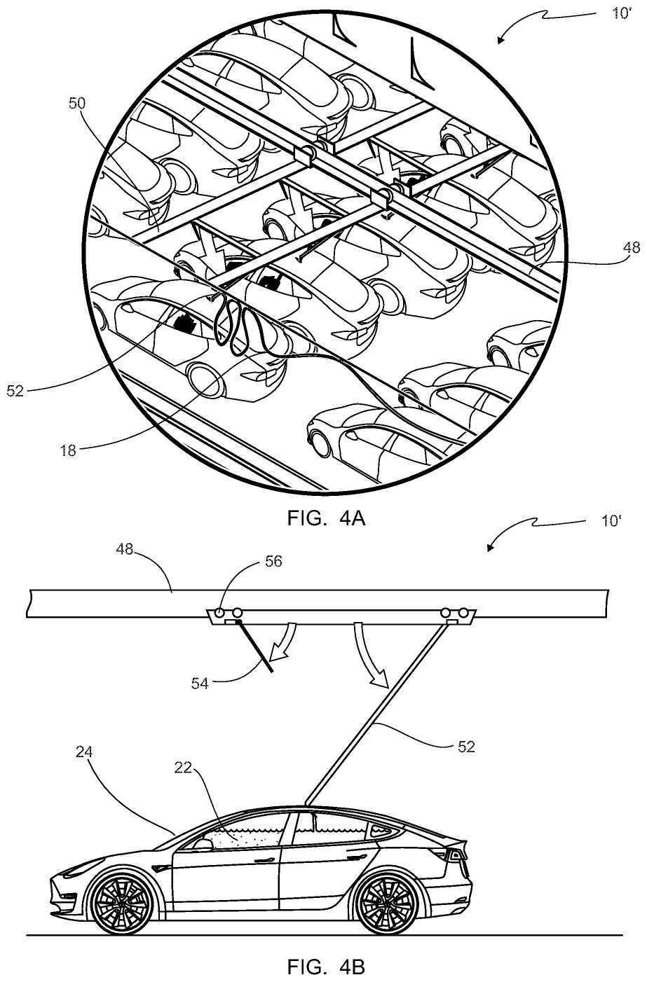

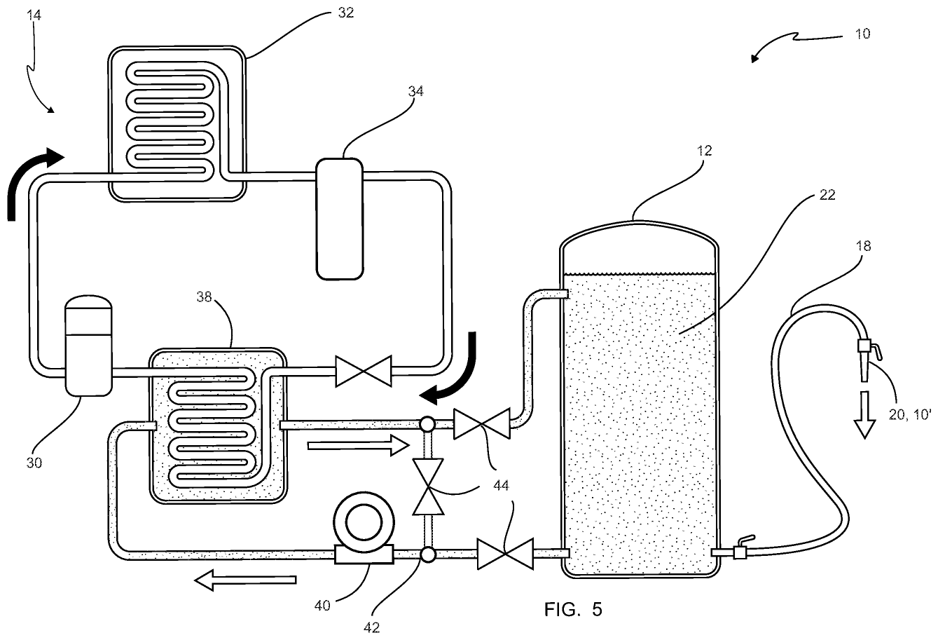

FIG. 4A shows a perspective view of a delivery system.

FIG. 4B shows a side view of a delivery system.

FIG. 5 shows a diagram of a cooling system for cooling the fire extinguishing medium.

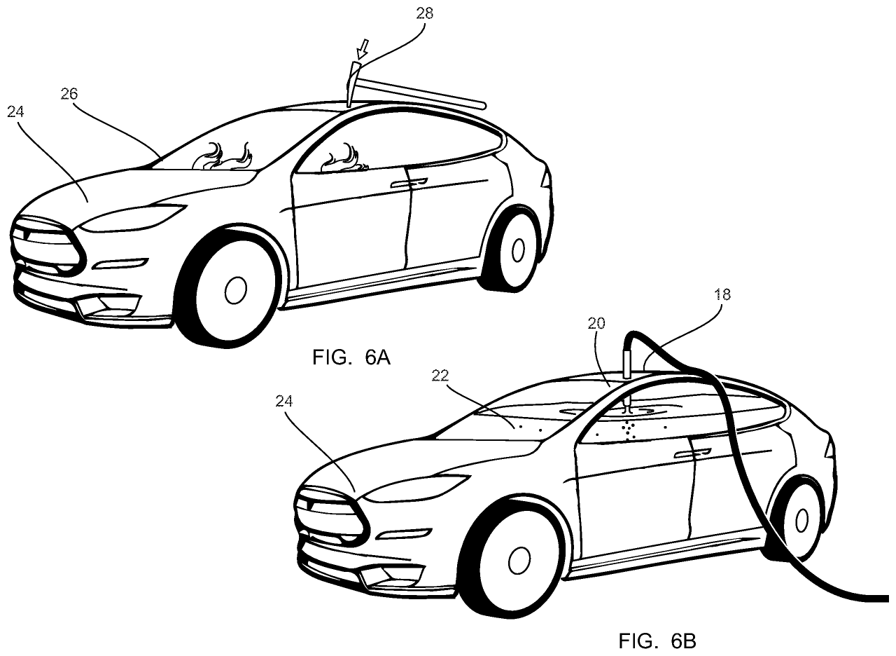

FIG. 6A shows a perspective view of a burning car.

FIG. 6B shows a perspective view of a car being filled with a fire extinguishing medium.

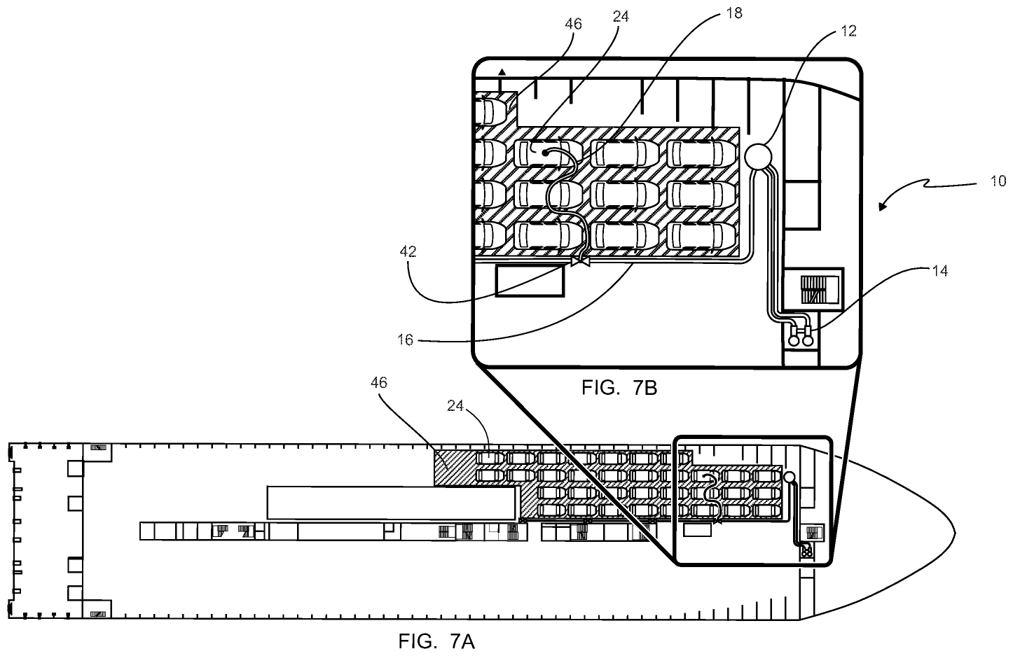

FIGS. 7A-7B show plan views through a ship.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will thus not be described in detail with respect to the description of each figure. The invention is in the following disclosed in relation to a parking area of a ship, but might as well be described in relation to the different types of parking areas, e.g., parking garages, underground parking, parking lots, tunnels etc.

FIG. 1-2 show perspective views of a ship having a parking area with a burning car 24. FIGS. 1 and 2 show the ship having a number of cars 24 being parked and where a number of the cars 24 are on fire. It is apparent that the fire may easily spread to the nearby located other cars, or even spread to the construction of the ship.

FIG. 3A shows a perspective view of a parking environment having an injection system 10′. A number of vehicles 24 are parked in rows and a number of the vehicles 24 are shown burning. The injection system 10′ comprises a guide system 48 arranged as a steel beam, positioned above the parked vehicles. The guide system may be position directly to a ceiling of the parking environment of may be arranged suspended therefrom. Onto the guide system 48 is arranged support means 50 comprised of two parallel arranged arms which support the combined piercing and injection means 52. The combined piercing and injection means 52 are connected to a storage medium (not shown) which contains the fire extinguishing medium. The combined piercing and injection means 52 are preferably connected to the storage means via a flexible delivery system, such as a hose, either directly or indirectly via a further stationary delivery system having a number of stationary pipes/conduits.

As illustrated by the arrows, the support means are longitudinally displaceable in relation to the guide system, such that the piercing and injection means 52 can be correctly positioned above the burning vehicles 24.

FIG. 3B shows a perspective view of an injection system 10′. The piercing and injection means 52 are, as illustrated by the arrow, moved on the guide system 48 and brought into a position above the vehicle 24.

FIG. 4A corresponds to the situation illustrated in FIG. 3A. The piercing and injection means have been brought into a correct position above the parked vehicles 24, and the piercing and injection means 52 has, as illustrated by the arrows, been brought from the first stored position, into a position where the piercing and injection means penetrate the vehicle 24. The movement from the first to the second position is made by a rapid motion of the piercing and injection means with a force suitable for forcing the piercing and injection means through the roof of the vehicle.

FIG. 4B illustrates the piercing and injection means being moved from the first stored position into a second position where the piercing and injection means 52 has penetrated the vehicle 24. After the piercing and injection means 52 has penetrated the vehicle 24, the fire extinguishing system 10 delivers the fire extinguishing medium 22 into the interior of the vehicle.

The injection and piercing is illustrated with releasing means 54 which ejects the piercing and injection means 52 from the first position into the second position, with a force suitable for penetrating the roof of the vehicle. The releasing means may be arranged as mechanical, pneumatic or hydraulic means, suitable for rapidly ejecting the piercing and injection means from the first position. The piercing and injection means thus functions as a hammer with a sharp piercing nozzle at the end, which penetrates the vehicle.

FIG. 5 shows a diagram of a cooling system 14 for cooling the brine 22. The illustrated cooling system 14 is one possible embodiment but it should be understood that the cooling system 14 may be arranged differently.

The system comprises a closed circuit having a refrigerant such as NH3 (ammonia) or other type of refrigerant such as Co2, freon etc. The closed circuit comprises a compressor 30 which compresses the ammonia which hereby increases the temperature of the ammonia. The heated vapor ammonia enters a cold condenser 32 which absorbs the heat from the ammonia which is converted into liquid. The condenser 32 is preferably connected to a cooling tower (not shown) which water cools the condenser. The liquid ammonia enters a receiver where it accumulates in order to deliver a continues amount of ammonia to the subsequent components. After the receiver, the high-pressure liquid ammonia enters an expansion valve 36 where it expands, and the pressure decreases whereby the temperature falls and the ammonia is a very cold liquid. The liquid and very cold ammonia then enter the evaporator 38 where the refrigerant effect occurs. The evaporator 38 is connected to the tank 12 by conduits, such that the brine 22, which is stored inside the tank 12 can be pumped, by a pump 40, through the evaporator 38 where the brine is cooled down to the desired temperature. Preferably, the pump 40 continuously pumps the brine through the evaporator 38 to keep a constant cold temperature of the brine inside the tank 12.

From the tank 12, the brine 22 is delivered to the car 24 (not shown) through the delivery system, which in the shown embodiment is illustrated by the second flexible delivery system 18.

The flexible delivery system may be connected to the combined piercing and injection means (52) (not shown in FIG. 5).

The conduits between the tank 12 and the evaporator are in a preferred embodiment, as shown, arranged with a bypass string having a bypass valve 44, and the circuits to and from the tank each comprise second bypass valves, such that the flow of brine through the evaporator 38 can circumvent the tank 12. It is hereby achieved that the tank 12 can be disconnected from the cooling system and transported elsewhere.

The fire extinguishing system further comprises pumping means (not shown), similar to the pump 40, for pumping the brine 22 from the tank and into the car 24.

FIGS. 6A and 6B show an alternative embodiment different from the claimed invention.

FIG. 6A shows a perspective view of a burning car 24. In order to be able to extinguish the flames 26 within the interior of the car 24 and prevent a spreading of the fire, a hole is being made in the roof construction such that the brine 22 may be injected into the interior of the car 24. The hole is being made by piercing means 28 which may be a piercing nozzle or other type of piercing means which is manually or automatically operated.

In order, for the car to carry the maximum mass of the cold brine, it is preferred to arrange the hole in the roof construction of the car. Alternatively, the brine may be injected into the car 24 through a broken window. The car will always have smaller openings, e.g. through the ventilation system or through the bottom of the car, where the brine will escape from the interior, and thereby some effect of the cool brine will be lost. It is therefore preferred, that the brine has a viscosity which is increased compared to the viscosity of water at 0 degrees Celsius. Hereby, the rate of brine flowing out is minimized.

FIG. 6B shows a perspective view of a car 24 being filled with brine 22. The second flexible delivery system 18 with the injection means 20 is arranged connected with the hole in the roof of the car 24, and the brine 22 is injected through the hole and into the car 24. After the car 24 has been substantially filled with brine, some amount of brine will leak out of the interior through openings. Therefore, the fire extinguishing system 10 will continue to inject brine into the car 24.

FIG. 7A shows a plane view of a cross-section through a ship.

The drawing shows the ship comprising a parking area 46 having a number of cars 24. It should be understood that the illustrated level of the ship may comprise a larger parking area 46 than the one shown. Adjacent the parking area 46 at the bow of the ship is illustrated a fire extinguishing system 10. Though the fire extinguishing system 10 is illustrated at the bow of the ship, it may be located elsewhere on the ship, e.g. at the stern or on a different level than the one shown.

FIG. 7B shows an enlarged view of a part of FIG. 7A. The figure shows an enlarged view of part of the parking area 46 having a number of parked cars 24.

The figure shows the fire extinguishing system 10, which in the shown embodiment comprises a storage medium 12, which in a preferred embodiment is a tank which stores the fire extinguishing medium preferably having a temperature below 0 degrees Celsius. The fire extinguishing medium will in the following be described as brine but should not be understood as limited to such definition The storage medium will in the following be described as a tank, but should not be understood as limited to such definition.

The fire extinguishing system 10 further comprises a cooling system 14 for cooling the brine 22. One embodiment of the cooling system 14 is described in relation to FIG. 4. The tank 12, which preferable is an insulated tank 12, stores the cooled brine 22, and the system is arranged with conduits between the tank 12 and the cooling system 14, such that the brine 22 can circulate between the tank 12 and the cooling system. It is hereby ensured that the cooling system 14 continuously cools the brine 22, such that the brine 22 in the tank 12 is stored at a specific constantly low temperature. Any loss of energy from the brine through the tank 12 and the conduits is therefore compensated for.

The fire extinguishing system 10 comprises a delivery system which is arranged for delivering the brine 22 which is stored in the tank into the interior of the car 24 with the burning or overheated battery.

The delivery system is illustrated with a first stationary delivery system 16′ which is connected to the tank 12, and which is preferably arranged as a series of pipes, preferably insulated pipes, which are connected to the construction of the ship, such as pipes installed to the walls or ceilings on the illustrated level of the ship.

The delivery system is further illustrated with a second flexible delivery system 18 which is connected to the first stationary delivery system 16′, and which is preferably arranged as a flexible hose, such as a hose similar to a firefighting hose. It should be understood, that instead of the illustrated flexible hose 18, or in connection with the flexible hose, the delivery system illustrated in FIG. 7B may comprises the injection system illustrated in FIGS. 2-4B.

The first stationary delivery system 16′ is arranged substantially along the entire parking area 46 and is preferably arranged with a number of connection points 42 located on the first stationary delivery system 16′ at specific intervals such that the second flexible delivery system 18 or the system of FIGS. 2-4B can be connected at any of these connection points, typically the connection point which is located closest to the car 24 in question. The connection points are preferably arranged as a hose valve, such as a hose valve which is typically found in fire hydrants.

The second flexible delivery system is optimally arranged with injection means 20 (shown in FIG. 3B), such as a nozzle for injecting the brine into the car 24 or connected to the delivery system 16 shown in FIGS. 2-4B.

In the following is given a list of reference signs that are used in the detailed description of the invention and the drawings referred to in the detailed description of the invention.
10 Fire extinguishing system
10′ Injection system
12 Storage medium
14 Cooling system
16 Delivery system
16′ Stationary delivery system
18 Flexible delivery system
20 Injection means
22 Fire extinguishing medium
24 Car
26 Flames
28 Piercing means
30 Compressor
32 Condenser
34 Receiver
36 Expansion valve
38 Evaporator
40 Pump
42 Connection point
44 Bypass valve
46 Parking area
48 Guide system
50 Support means
52 Combined piercing and injection means
54 Release mechanism
56 Conveying means

1. A fire extinguishing system for extinguishing a fire in a vehicle, such as an electric car, said system comprising:
a storage medium, such as a tank, being external to said vehicle, and containing a fire extinguishing medium;
a cooling system for cooling said fire extinguishing medium to a sub-zero temperature, and
a delivery system for delivering said fire extinguishing medium from said storage medium to the inside of said vehicle,
said delivery system comprising an injection system having mechanically operated and combined piercing and injection means, for piercing and injecting said fire extinguishing medium into said car.

2. A fire extinguishing system according to claim 1, wherein said combined piercing and injection means, being arranged as a mechanically moving element, moveable between two positions, a first stored position in which said piercing and injection means are disengaged from said vehicle, and a second deployed position, where said piercing and injection means have pierced said vehicle such that said fire extinguishing medium may be delivered into said vehicle through said combined piercing and injection means.

3. A fire extinguishing system according to claim 2, wherein said delivery system comprising a guide system, such as a number of steel beams onto which said combined piercing and injection means, are moveable connected, such that said combined piercing and injection means are displaceable in a longitudinal direction of said guide system.

4. A fire extinguishing system according to claim 2, wherein said delivery system comprising support means, supporting said combined piercing and injection means, said support means comprising a release mechanism, for releasing said combined piercing and injection means from said first position into said second position.

5. A fire extinguishing system according to any of the previous claims, wherein said fire extinguishing medium being a brine.

6. A fire extinguishing system according to claim 1, wherein said fire extinguishing medium comprising an antifreeze liquid coolant.

7. A fire extinguishing system according to claim 1, wherein said fire extinguishing medium having a temperature of below 0 degrees, preferably a temperature below degrees, such as between and degrees, most preferred between and degrees.

8. A fire extinguishing system according to claim 5, wherein the viscosity of the fire extinguishing medium is increased compared to the viscosity of water at 0 degrees Celsius.

9. A fire extinguishing system according to claim 5, wherein said brine has a concentration of above 20%.

10. A fire extinguishing system according to claim 1, wherein said storage medium, having a storing capacity being substantially equal to or higher than a predetermined volume corresponding to an estimated internal volume of said vehicle.

11. A fire extinguishing system according to claim 1, wherein said system comprises a salt concentration regulating mechanism.

12. A fire extinguishing system according to claim 1, wherein said cooling system is arranged for circulating said fire extinguishing medium, said storage medium and said cooling system being arranged modularly, such that said storage medium can be disconnected from said cooling system.

13. A vehicle parking environment comprising a vehicle parking area and a fire extinguishing system according to claim 1.

14. A method for extinguishing a fire in a vehicle, such as an EV, said method comprising the following steps:
providing a fire extinguishing system;
providing an opening into said vehicle by said combined piercing and injection means;
injecting a fire extinguishing medium via said combined piercing and injection means through said opening and into said vehicle; and
optionally continuing injecting said fire extinguishing medium until said vehicle is between half and substantially filled with said fire extinguishing medium, and
optionally continuing injecting said fire extinguishing medium after said vehicle is substantially completely filled with said fire extinguishing medium.

15. A method according to claim 14, wherein said step of providing an opening into said vehicle by said combined piercing and injection means, comprises an operation of said combined piercing and injection means from a first stored position, in which said piercing and injection means are disengaged from said vehicle, and into a second deployed position, where said piercing and injection means have pierced said vehicle such that said fire extinguishing medium can be delivered into said vehicle through said combined piercing and injection means.

16. A method according to claim 15, wherein preceding said step of providing an opening into said vehicle, said method comprises a positioning step, where said combined piercing and injection means are moved on a guide system, such that said combined piercing and injection means are maneuvered into a correct position above said vehicle before said combined piercing and injection means are released from said first position into said second position.
